(19) United States
(12) Patent Application Publication
(10) Pub. No.: US 2019/0304242 A1
(43) Pub. Date: Oct. 3, 2019

(54) Game Information Switching System

(71) Applicant: Bingotimes Digital Technology Co., Ltd, Taichung City (TW)

(72) Inventor: Kuo-Lung Tseng, Taichung City (TW)

(21) Appl. No.: 15/942,413

(22) Filed: Mar. 30, 2018

(51) Int. Cl. G07F 17/32

(52) U.S. Cl. CPC G07F 17/3209; G07F 17/3288; G07F 17/3211; G07F 17/3276; G07F 17/323

(57) ABSTRACT

A game information switching system is disclosed. A touch screen device of each player-side game machine is provided with a player operation interface. The player operation interface has a main game field, a brief game information field, and a menu key. The menu key can open a display history list. Clicking the display history list can display a detailed game history information field. A display/hide key is provided below the brief game information field to display/hide a field control area. The field control area can be controlled to open or hide a mode switching menu. A grid control field is provided below the detailed game history information field for switching the number of grids. Through the above system, the player can simultaneously and quickly obtain the game information of a plurality of games to evaluate a suit for placing a bet, thereby enhancing the interest of players and increasing the store's turnover.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a game information switching system, and more particularly to a game information switching system able to switch and display brief and detailed game information modes.

### Description of Related Arts

As shown in FIGS. 1 to 4, a conventional electronic game system includes a plurality of game hosts 10 and a plurality of player-side game machines 11. Wherein, the game hosts 10 are communicated with the player-side game machines 11. Each of the game hosts 10 is installed with at least one game program. Each of the player-side game machines 11 has a touch screen device 12 and an input device 13. The screen of the touch screen device 12 is provided with a player operation interface 20. The player can switch, operate and execute the game programs of the game hosts 10 through the player operation interface 20. The input device 13 may be a keyboard or a mouse. The player operation interface 20 has a main game field 21, a brief game information field 22, and a menu key 23. The main game field 21 includes a bet selection area 211, a message area 212, a history record area 213, a total bet area 214, a bet area 215, a score area 216, a time area 217, and a prompt area 218. The menu key 23 is configured to open a submenu 30 and display a plurality of options for the player to click. The brief game information field 22 is divided into a plurality of game unit field frames 24. The game unit field frames 44 correspondingly display a plurality of brief game information of the game hosts 10 respectively, including a game category graphic information area 241, a game name information area 242, a round information area 234, a bet information area 244, a score information area 245, and a time information area 246. Taking the Baccarat game of poker games for example, the time area 217 displays the countdown time, in which the bet amount of the player is displayed in the total bet area 214. The bet selection area 211 may be selected for placing a bet. When the bet time ends, the game host 10 starts to distribute cards to the players and the bankers according to the rules of the Baccarat game and display the cards on the main game bar 21 and further to bring a game result. In this way, the game of each round of the Baccarat game can be performed one after another. The message area 212 may display the winning odds or the in-progress game information. The history record area 213 displays the game result records of many rounds of the game. The total bet area 214 displays the bets currently held by the player. The bet area 215 displays the player's bet value of the previous round. The score area 216 displays the player's score value of the previous round. When the bet time of the present round ends, the player may focus on the game of the main game field 21 from the beginning of the game to distribute the cards until the countdown of next round. The player may further view the real-time status of other games via the brief game information field, that is, the player can know the current status of other game machines so that the player can obtain the information of different games and determine whether to participate in the bets of different games. The player can know the category of the game via the game category graphic information area 241 of the brief game information field 22. The player can know the name information of the game host 10 via the game name information area 242. The player can know the round of the game via the round information area 243. The player can know the bet value in the game via the bet information area 244. The player can know the score value in the game via the score information area 245. The player can know the bet time via the time information area 246. The bet time may be a countdown number display mode. The player can select the game category graphic information area 241 of the game unit field frame 24 by touch, that is, the main game field 21 can be switched to the selected game category, and the result can be recorded. The records of the history record area 213 can be used to evaluate the suit of the follow-up card for placing a bet. In this way, the player may bet on multiple games through the player operation interface 20, thereby increasing the player's total bet amount and increasing the revenue of the store. However, the above electronic game, in fact, has the following disadvantages:

1. The player can learn about the game status of a plurality of games at the same time via the brief game information field 22, and toggle the game unit field frame 24 by touch or scroll the game unit field frame 24 up and down through the input device 13 to display all games. But, due to the need to display the information of multiple different games simultaneously, it is only possible to provide information within the game unit field frame 24 as simple as possible. Such information is actually not sufficient for the player to evaluate whether to participate in the game, and the information provided is too monotonous, without change. It is impossible for the player to know more about the status of other games, which will reduce the player's interest in betting.

2. The player can learn about the suits of the distributed cards of the previous rounds of the in-progress game through the history record area 213. For example, in the Baccarat game, the player may bet on banker or player as the result that the banker consecutively wins the game. The player may click another game in the brief game information field 22 not in the bet time of the main game field 21, so that the main game field 21 can switch the main screen of another game to view its history result records in detail for the player to guess the possible suit of next round to place a bet. However, if the player wants to view the history result records of more than three games, the main game field 21 is always switched. They player may not have enough time to view the history records of the game within the bet time, so the player does not have the complete information to evaluate whether or not to bet on other games. This will decrease the player's bet amount and affect the revenue of the store.

Accordingly, the inventor of the present invention has devoted himself based on his many years of practical experiences to solve these problems.

### SUMMARY OF THE PRESENT INVENTION

The primary object of the present invention is to solve the aforesaid problems and to provide a game information switching system. A brief game information field of the present invention is provided with a display/hide key. Clicking the display/hide key can open a field control area. The field control area includes a mode start key. Clicking the mode start key can display a mode switching menu for selecting and switching a combination of the game information. A menu key of the present invention can open a submenu. The options of the submenu include a display path. Clicking the display history list can open a detailed game history information field for providing the detailed history records of each game. Through the above system, the brief game information field can be switched according to the player's requirement and clicking the display history list can simultaneously display the detailed history information of the plurality of games, so that the player can obtain the detailed information of the games easily and quickly and can instantly evaluate the follow-up suits of the games, thereby attracting a bet and increasing the amount of the bet.

In order to achieve the aforesaid object, the game information switching system of the present invention comprises a plurality of game hosts and a plurality of player-side game machines. The game hosts are communicated with the player-side game machines.

Each of the game hosts is installed with at least one game program. Each of the player-side game machines has a touch screen device and an input device. A screen of the touch screen device is provided with a player operation interface. The player operation interface is able to switch, operate and execute the game programs of the game hosts. The player operation interface has a main game field, a brief game information field, and a menu key. The main game field includes a bet selection area and a history record area. The menu key is configured to open a submenu and display a plurality of options for a player to click. The options of the submenu include a display history list. The display history list is touched or selected through the input device to switch the main game field to display a detailed game history information field. The brief game information field is divided into a plurality of game unit field frames. The game unit field frames correspondingly display a plurality of brief game information of the game hosts, respectively. A display/hide key is provided below the brief game information field. Clicking the display/hide key is able to display/hide a field control area. The field control area includes a mode start key to pen or hide a mode switching menu. The mode switching menu includes a plurality of modes for selecting and switching information of the game unit field frames. The detailed game history information field includes a plurality of grids and a grid control field beneath the grids. The grids display detailed history records of a plurality of games of the game hosts, respectively. The grid control field is provided with a grid mode selection area. The grid mode selection area includes a plurality of modes for selecting and switching the number of the grids.

In an embodiment of the present invention, the game unit field frame is selected from a combination of game information areas, including a game category graphic information area, a game name information area, a bet information area, a score information area, a round information area, a previous round information area, a history information area, and a time information area.

In an embodiment of the present invention, the mode switching menu includes A, B, C and D modes for selecting and switching the information of the game unit field frames. When the mode switching menu selects the A mode, the game unit field frame of the brief game information field displays the game category graphic information area, the game name information area, the bet information area, the score information area, the round information area, the previous round information area, and the history information area. When the mode switching menu selects the B mode, the game unit field frame of the brief game information field displays the game category graphic information area, the game name information area, the bet information area, the score information area, the round information area, the previous round information area, and time information area. When the mode switching menu selects the C mode, the game unit field frame of the brief game information field displays the game category graphic information area, the game name information area, the bet information area, and the score information area. When the mode switching menu selects the D mode, the game unit field frame of the brief game information field displays the game category graphic information area, the game name information area, the bet information area, the score information area, the round information area, and time information area.

In an embodiment of the present invention, the grid mode selection area includes A, B and C modes for selection. When the A mode is selected, the detailed game history information field displays six grids. When the B mode is selected, the detailed game history information field displays nine grids. When the C mode is selected, the detailed game history information field displays twelve grids.

In an embodiment of the present invention, the grids display a game category graphic information area, a round information area, a total bet information area, a game name information area, a time information area and a history information area, respectively.

Through the above system, the brief game information can switch the display mode and the detailed game history information field can switch the game history information, so that the player can simultaneously and quickly obtain the necessary information of a plurality of in-progress games for placing a bet. The players are encouraged to bet on their favorite games so as to increase their interest and the bet amount, which will in turn increase the store's turnover.

### BRIEF DESCRIPTION OF THE DRAWINGS

FIG. 1 is a schematic view of a conventional game system;

FIG. 2 is a schematic view of a conventional player operation interface;

FIG. 3 is a schematic view of a conventional sub-menu;

FIG. 4 is a schematic view of a conventional brief game information field;

FIG. 5 is a schematic view of the player operation interface of the present invention;

FIG. 6 is a schematic view of the sub-menu of the present invention;

FIG. 7 is a schematic view of the field control area displayed in the brief game information field of the present invention;

FIG. 8 is a schematic view of the mode switching menu displayed in the brief game information field of the present invention;

FIG. 9 is a schematic view of the A mode of the game unit field frame of the present invention;

FIG. 10 is a schematic view of the B mode of the game unit field frame of the present invention;

FIG. 11 is a schematic view of the C mode of the game unit field frame of the present invention;

FIG. 12 is a schematic view of the D mode of the game unit field frame of the present invention;

FIG. 13 is a schematic view of the configuration of the detailed game history field of the present invention;

FIG. 14 is a schematic view of the A mode of the detailed game history field of the present invention;

FIG. 15 is a schematic view of the B mode of the detailed game history field of the present invention;

FIG. 16 is a schematic view of the C mode of the detailed game history field of the present invention; and

FIG. 17 is a schematic view of the grids of the present invention.

### DETAILED DESCRIPTION OF THE PREFERRED EMBODIMENT

Embodiments of the present invention will now be described, by way of example only, with reference to the accompanying drawings.

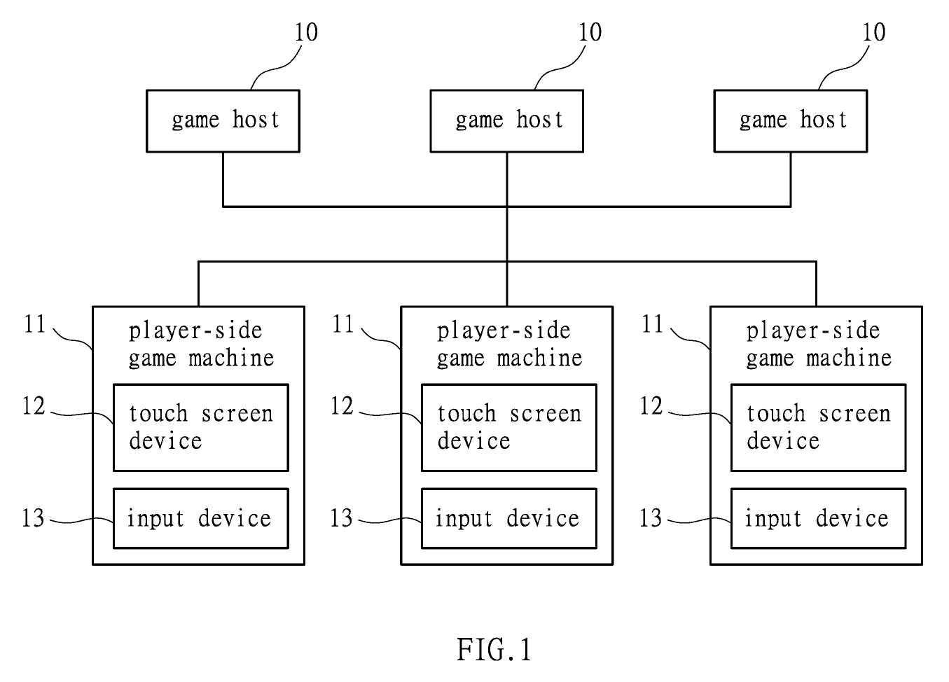

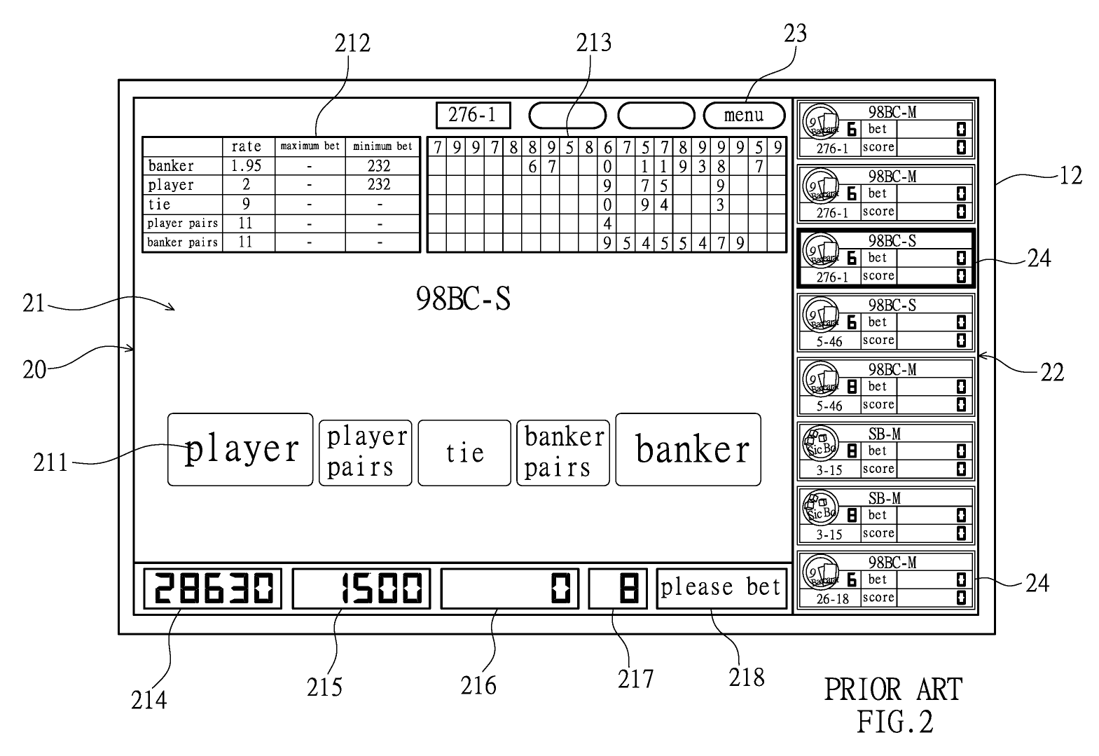

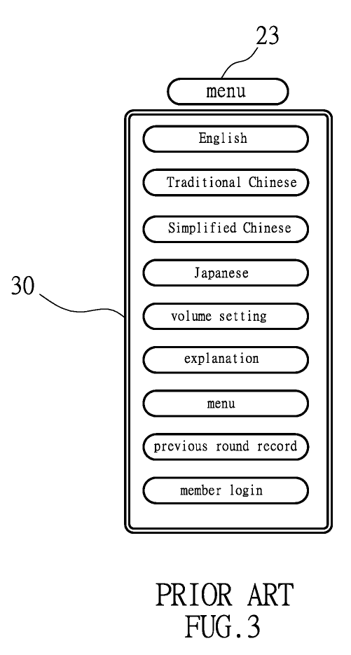

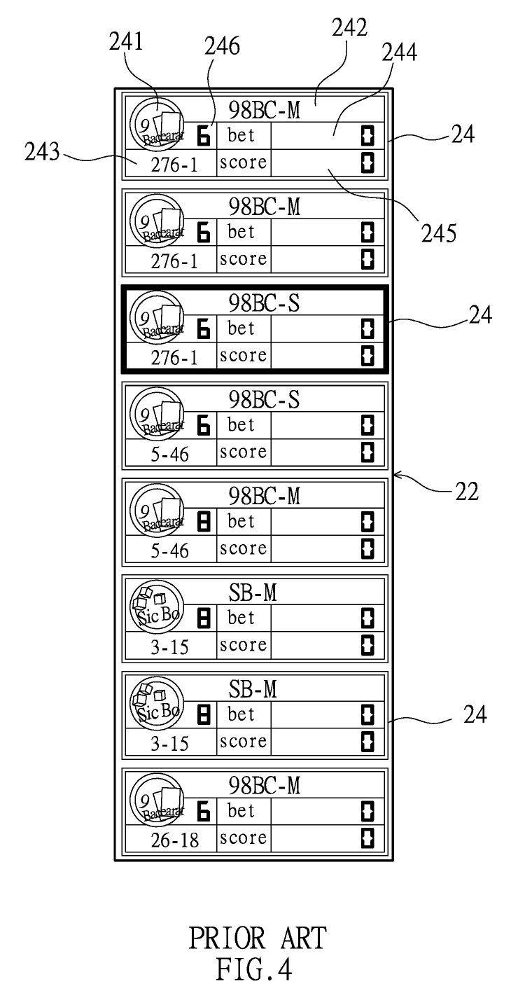

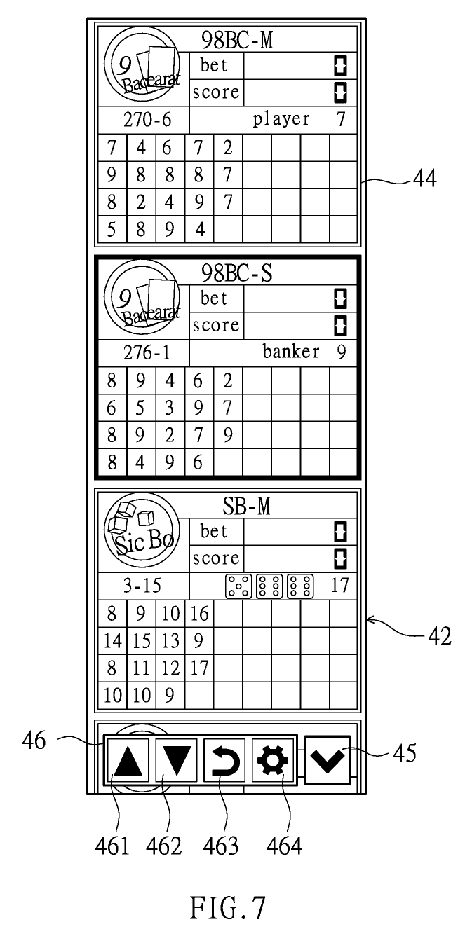

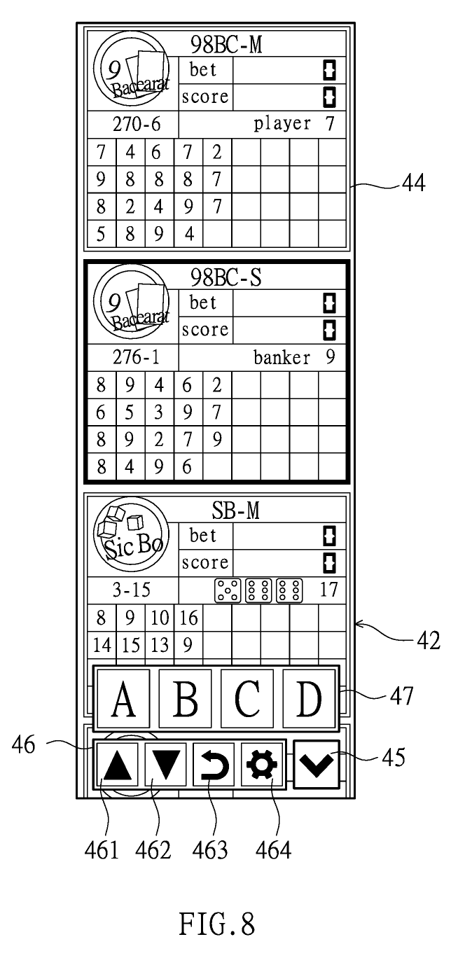

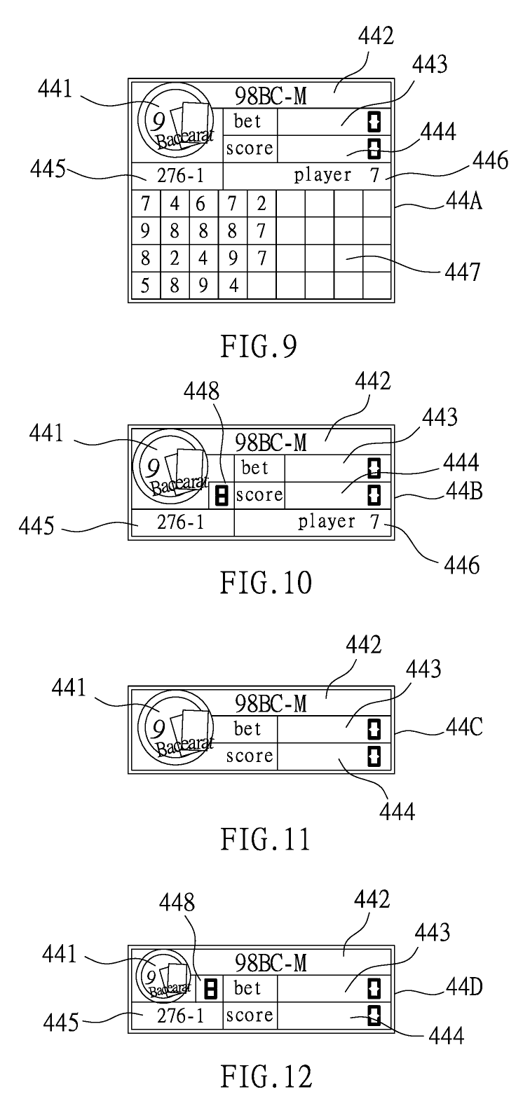

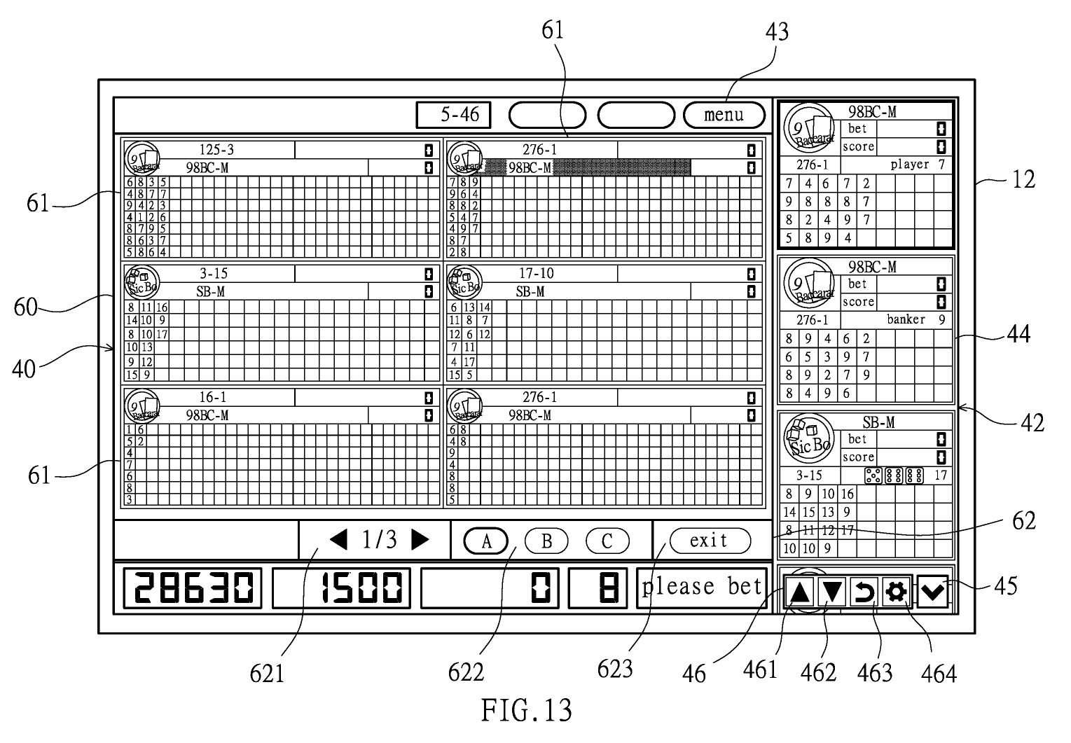

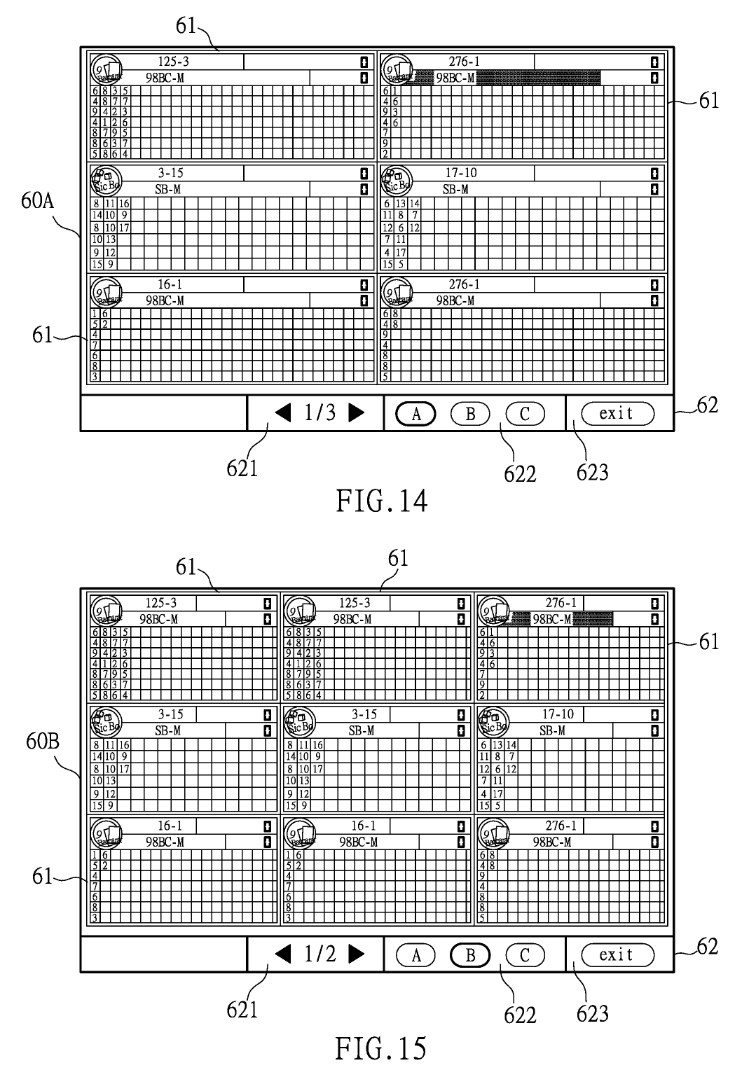

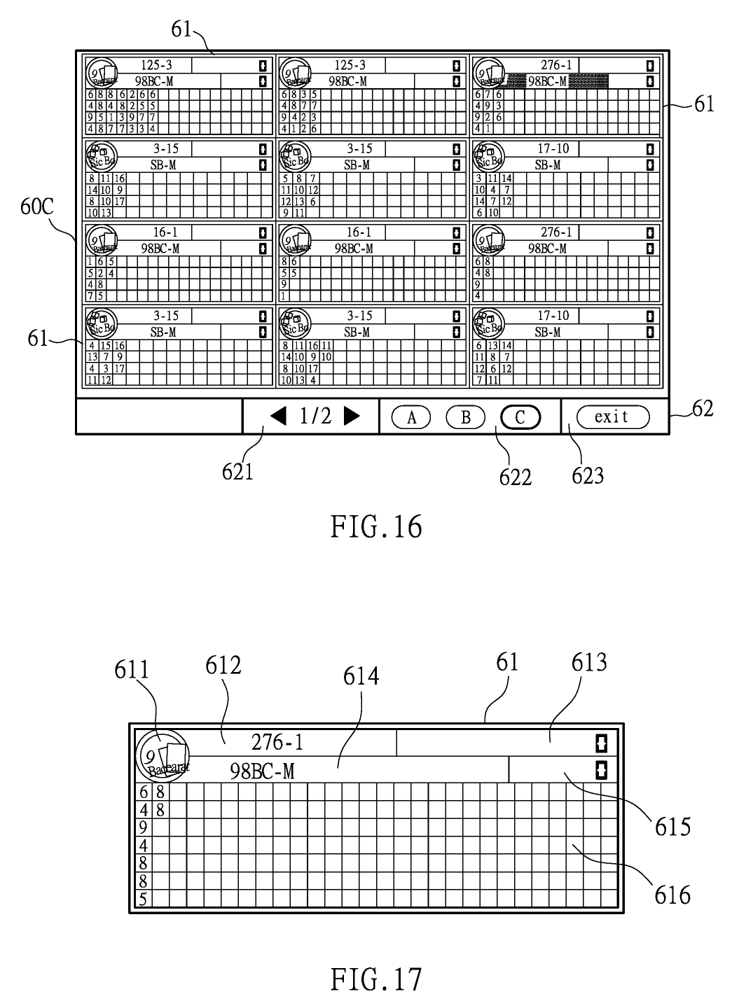

Referring to FIGS. 1, 5 to 17, the present invention discloses a game information switching system, comprising a plurality of game hosts 10 and a plurality of player-side game machines 11. Wherein, the game hosts 10 are communicated with the player-side game machines 11. Each of the game hosts 10 is installed with at least one game program. Each of the player-side game machines 11 has a touch screen device 12 and an input device 13. The screen of the touch screen device 12 is provided with a player operation interface 40. The player can switch, operate and execute the game programs of the game hosts 10 through the player operation interface 40. The input device 13 may be a keyboard or a mouse. The player operation interface 40 has a main game field 41, a brief game information field 42, and a menu key 43. The main game field 41 includes a bet selection area 411 and a history record area 412. The menu key 43 is configured to open a submenu 50 and display a plurality of options for the player to click. The options include a display history list 51. Clicking the display history list 51 can switch the main game field 41 to display a detailed game history information field 60. The brief game information field 42 is divided into a plurality of game unit field frames 44. The game unit field frames 44 correspondingly display a plurality of brief game information of the game hosts 10, respectively. A display/hide key 45 is provided below the brief game information field 42. Clicking the display/hide key 45 can display/hide a field control area 46. The field control area 46 includes an up-scrolling key 461 and a down-scrolling key 462, a return key 463, and a mode start key 464. Clicking the mode start key 464 can open or hide a mode switching menu 47. The mode switching menu 47 includes four modes of A, B, C and D for selecting and switching the information of the game unit field frames 44. The game unit field frame 44 is selected from a combination of the following game information areas, including a game category graphic information area 441, a game name information area 442, a bet information area 443, a score information area 444, a round information area 445, a previous round information area 446, a history information area 447, and a time information area 448. When the mode switching menu 47 selects the A mode, the game unit field frame 44A (as shown in FIG. 9) of the brief game information field 42 displays the game category graphic information area 441, the game name information area 442, the bet information area 443, the score information area 444, the round information area 445, the previous round information area 446, and the history information area 447. When the mode switching menu 47 selects the B mode, the game unit field frame 44B (as shown in FIG. 10) of the brief game information field 42 displays the game category graphic information area 441, the game name information area 442, the bet information area 443, the score information area 444, the round information area 445, the previous round information area 446, and time information area 448. When the mode switching menu 47 selects the C mode, the game unit field frame 44C (as shown in FIG. 11) of the brief game information field 42 displays the game category graphic information area 441, the game name information area 442, the bet information area 443, and the score information area 444. When the mode switching menu 47 selects the D mode, the game unit field frame 44D (as shown in FIG. 12) of the brief game information field 42 displays the game category graphic information area 441, the game name information area 442, the bet information area 443, the score information area 444, the round information area 445, and time information area 448. As shown in FIGS. 13 to 16, the detailed game history information field 60 includes a plurality of grids 61 and a grid control field 62 beneath the grids 61. The grids 61 display detailed history records of a plurality of games of the game hosts 10, respectively. The grid control field 62 is provided with a page control key 621, a grid mode selection area 622 and an exit key 623. The grid mode selection area 622 includes three modes of A, B and C for selection. When the A mode is selected, the detailed game history information field 60A (as shown in FIG. 14) displays six grids 61. When the B mode is selected, the detailed game history information field 60B (as shown in FIG. 15) displays nine grids 61. When the C mode is selected, the detailed game history information field 60C (as shown in FIG. 16) displays twelve grids 61. The brief game information field 42 can switch the display mode and the detailed game history information field 60 can switch the game history information, so that the player can simultaneously and quickly obtain and evaluate the necessary information of a plurality of in-progress games for placing a bet. The players are encouraged to bet on their favorite games so as to increase their interest and the bet amount, which will in turn increase the store's turnover.

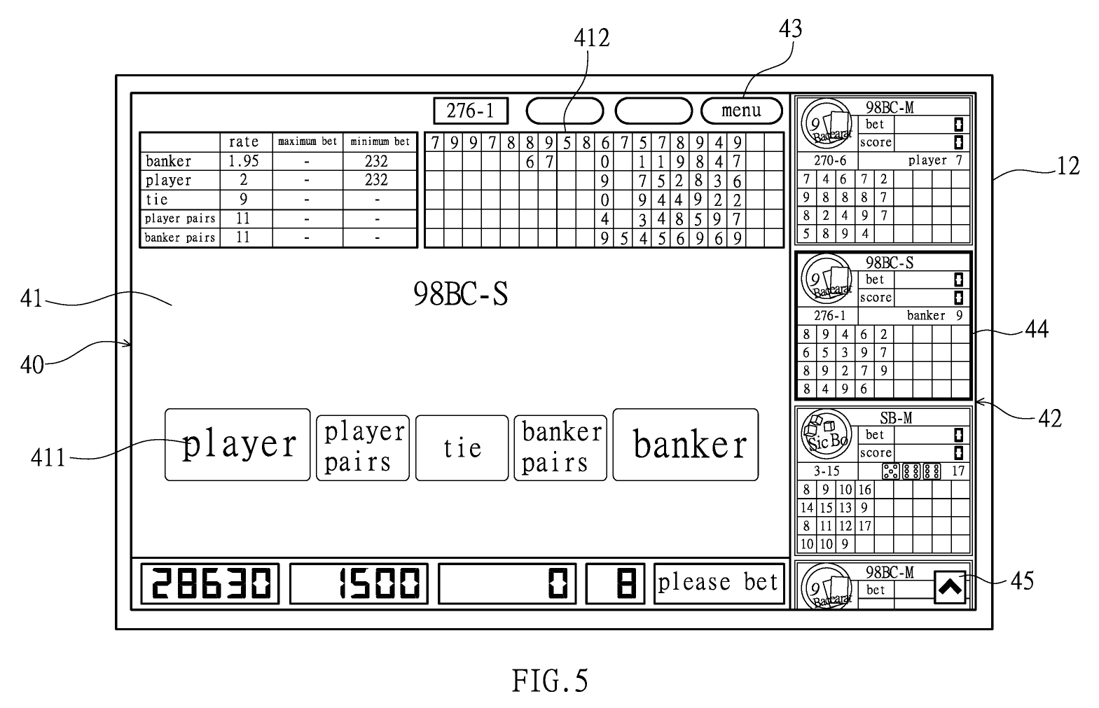

The assembly and details of the present invention are described below. As shown in FIGS. 5 to 16, the player may select one of the games in the brief game information field 42 to display the game screen on the main game field 41 for placing a bet. The history record area 412 provides a detailed outcome of multiple previous rounds of the game, including the suit and point of the winner. (The format of the information provided by the history record area 412 is a conventional information format, and the details are not described herein again.) The player can view the current information of other games through the brief game information field 42. The up-scrolling key 461 and the down-scrolling key 462 can be used to scroll up and down the games so as to view the game information in the game unit field frames 44 of the brief game information field 42 one by one. As shown in FIGS. 1, 5 to 13, each of the game unit field frames 44 provides the player with the game information of a plurality of combinations. Wherein, the same game in which the main game field 41 is in progress is marked with a color field frame. The player can touch or click the display/hide key 45 through the input device 13 (such as a mouse) to activate and display the field control area 46. Clicking the mode start key 464 can display the mode switching menu 47 to select the desired mode. By clicking the display/hide key 45 again, the field control area 46 can be hidden to reduce the display area occupied by the brief game information field 42. The return key 463 can provide the player with the convenience of switching to the previous view mode in the current view mode of the brief game information field 42. In the differences among the modes, the round information area 445 enables the player to know a new round or an old round. The previous round information area 446 enables the player to know the winners of the previous rounds of the game. The history information area 447 displays the outcome of the previous rounds. The player can touch or click the game category graphic information area 441 to switch the main game field 41 to the selected game, so that the player can place a bet in the main game field 41 within the bet time. Therefore, the mode switching menu 47 is used to switch the brief game information to provide the players with the desired game information, so as to attract the players to bet on various games and enhance the bet amount.

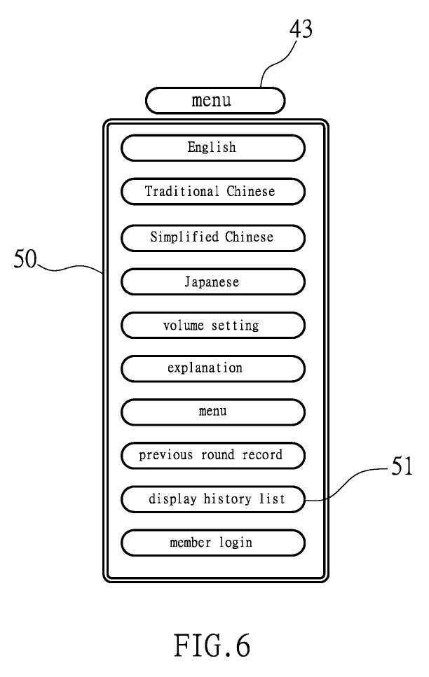

Please refer to FIGS. 5, 6 and 13 to 17. If the player wants to conduct a more detailed evaluation of the possible suit of a game for placing a bet, the user may touch or click the menu key 43 to display the sub-menu 50 (as shown in FIG. 6) and click one of the options, the display history list 51, and the main game field 41 can be switched to display the detailed game history information field 60 (as shown in FIG. 13). On the contrary, clicking the exit key 623 is to close the detailed game history information field 60 and return to the game screen of the main game field 41. The detailed game history information field 60 can be touched or clicked to select the grid mode selection area 622 of the grid control field 62 for switching the number of the grids 61 in the detailed game history information field 60. Clicking the page control key 621 enables the detailed game history information field 60 to switch the page for the player to view the other game information. The detailed game history information field 60 provides the player with the complete history of the drawing record of the game and other game details for the player to judge the follow-up suit. The grids 61 display a game category graphic information area 611, a round information area 612, a total bet information area 613, a game name information area 614, a time information area 615 and a history information area 616 (as shown in FIG. 17) of the game, respectively. Wherein, the player can click the game category graphic information area 611 to rapidly switch the record style of the history information area 616. The style has different information according to the category of the game. The history result record is a conventional record information manner, so it won't be described hereinafter. The game name information area 614 may be different in color from other games for marking the game that the main game field 41 is in progress. The time information area 615 displays a countdown time as a bet time. The total bet information area 613 provides the total bet amount of all the players in the game and provides the player with the information whether the game is popular or not. Therefore, when the player wants to place a bet on the desired game, the player can switch to display the information of various games to evaluate the bet so as to attract the players to bet on various games to increase the bet amount.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A game information switching system, comprising a plurality of game hosts and a plurality of player-side game machines; the game hosts being communicated with the player-side game machines; each of the game hosts being installed with at least one game program, each of the player-side game machines having a touch screen device and an input device, a screen of the touch screen device being provided with a player operation interface, the player operation interface being able to switch, operate and execute the game programs of the game hosts; the player operation interface having a main game field, a brief game information field and a menu key; the main game field including a bet selection area and a history record area, the menu key being configured to open a submenu and display a plurality of options for a player to click; the options of the submenu including a display history list, the display history list being touched or selected through the input device to switch the main game field to display a detailed game history information field; the brief game information field being divided into a plurality of game unit field frames, the game unit field frames correspondingly displaying a plurality of brief game information of the game hosts respectively, a display/hide key being provided below the brief game information field, clicking the display/hide key being able to display/hide a field control area; the field control area including a mode start key to pen or hide a mode switching menu; the mode switching menu including a plurality of modes for selecting and switching information of the game unit field frames; the detailed game history information field including a plurality of grids and a grid control field beneath the grids, the grids displaying detailed history records of a plurality of games of the game hosts respectively; the grid control field being provided with a grid mode selection area, the grid mode selection area including a plurality of modes for selecting and switching the number of the grids.

2. The game information switching system as claimed in claim 1, wherein the game unit field frame is selected from a combination of game information areas, including a game category graphic information area, a game name information area, a bet information area, a score information area, a round information area, a previous round information area, a history information area, and a time information area.

3. The game information switching system as claimed in claim 2, wherein the mode switching menu includes A, B, C and D modes for selecting and switching the information of the game unit field frames; when the mode switching menu selects the A mode, the game unit field frame of the brief game information field displays the game category graphic information area, the game name information area, the bet information area, the score information area, the round information area, the previous round information area, and the history information area; when the mode switching menu selects the B mode, the game unit field frame of the brief game information field displays the game category graphic information area, the game name information area, the bet information area, the score information area, the round information area, the previous round information area, and time information area; when the mode switching menu selects the C mode, the game unit field frame of the brief game information field displays the game category graphic information area, the game name information area, the bet information area, and the score information area; when the mode switching menu selects the D mode, the game unit field frame of the brief game information field displays the game category graphic information area, the game name information area, the bet information area, the score information area, the round information area, and time information area.

4. The game information switching system as claimed in claim 1, wherein the grid mode selection area includes A, B and C modes for selection; when the A mode is selected, the detailed game history information field displays six grids; when the B mode is selected, the detailed game history information field displays nine grids; when the C mode is selected, the detailed game history information field displays twelve grids.

5. The game information switching system as claimed in claim 4, wherein the grids display a game category graphic information area, a round information area, a total bet information area, a game name information area, a time information area and a history information area, respectively.
